(19) United States
(12) Patent Application Publication
(10) Pub. No.: US 2014/0282140 A1
(43) Pub. Date: Sep. 18, 2014

(54) METHOD FOR MOBILE CONTENT MANAGEMENT

(71) Applicant: Outright, Inc., Sunnyvale, CA (US)

(72) Inventors: Dominik Balogh, Belmont, CA (US); Pavel Serbajlo, Belmont, CA (US)

(73) Assignee: Outright, Inc., Sunnyvale, CA (US)

(21) Appl. No.: 13/801,546

(22) Filed: Mar. 13, 2013

(51) Int. Cl. G06F 3/0486

(52) U.S. Cl. CPC G06F 3/0486
USPC 715/765

(57) ABSTRACT

A system and method for mobile content management are provided. An arrangement of display elements are displayed, for example using a touch screen interface of a mobile device. A first control input is received causing one of the display elements to be selected. The selected one of the display elements has a first position in the arrangement of display elements. A second control input is received, the second control input indicating that the selected display element is to be repositioned to a second position within the arrangement of display elements. The selected display element is repositioned to the second position within the arrangement of display elements.

### CROSS-REFERENCE TO RELATED APPLICATIONS

This application is related to U.S. patent application Ser. No. ______, filed on ______, and entitled “SYSTEM FOR MOBILE CONTENT MANAGEMENT.”

This application is related to U.S. patent application Ser. No. ______, filed on ______, and entitled “SYSTEM AND METHOD FOR RETRIEVING AND SELECTING CONTENT.”

### FIELD OF THE INVENTION

The present invention generally relates to data communications with mobile devices, and more specifically, the present invention relates to systems and methods for aggregating and arranging content for transmission to remote computer system using a mobile device.

### BACKGROUND OF THE INVENTION

Today's mobile devices, such as smart phones, have the capability to run a rich array of software applications providing many different types of services and functionality to users. As such, in addition to becoming the primary means of communication for many people, in many cases mobile devices represent a user's primary computing device. In situations in which a user would ordinarily require access to a desktop computer to perform certain activities, those activities can instead be performed on the user's mobile device. Users regularly use their smart phones to draft emails and documents, edit photographs and videos, read web page content, and transmit or receive media.

Although the capabilities of mobile devices are substantial, a primary attribute of a mobile device is the device's relatively small size. The relatively small size is important as it allows the mobile device to be easily carried by a user. If the device is too big, it is no longer mobile, greatly reducing the device's utility over conventional computing devices such as desktop and laptop computers. As a consequence of the device's relatively small size, the device's user interfaces are relatively limited. Although the mobile device may include a small number of buttons, and the like, the primary user interface of a mobile device is often a touch screen. The touch screen enables the user to perform certain actions such as selecting items, typing, dragging, and zooming into or away from certain elements.

An example activity that is commonly performed using conventional computing devices, including desktop computer and laptops, is the creating and editing of web page content. The information and content included within a particular web page is generally specified in the form of programmed source code that a browser interprets to determine what to display on a viewing device. The source code may include document formats, objects, parameters, positioning instructions, and other code that is defined in one or more web programming or markup languages. One web markup language is HyperText Markup Language (“HTML”), and all web pages use HTML to some extent. HTML uses text indicators called tags to provide interpretation instructions to the browser. The tags specify the composition of design elements such as text, images, shapes, hyperlinks to other web pages, programming objects such as JAVA applets, form fields, tables, and other elements.

Because many users do not wish to enter a web page's code by hand, a number of software applications have been developed to assist a user in constructing web pages. These applications include a number of graphical user interface elements that enable users to quickly and easily build website content using a number of simple user interface devices. Often the user is able to use a simple “drag-and-drop” interface to place and rearrange elements on the page, in combination with a keyboard to enter text. Once the web page has been created, its contents are published to a web server where they are made publicly available over the Internet. These software applications, though, are constructed in the presumption that the applications will be accessed using a conventional desktop computer or laptop. As such, the user interfaces of these software applications, while appropriate for a large display in combination with a keyboard and mouse (the usual user interface devices associated with those types of computers), are not appropriate for the small touch screen interface associated with most mobile devices.

Consequently, a user attempting to use a conventional website development suite of software to construct a web page on a mobile device, presuming such software would be compatible with the mobile device, would find the user interface difficult, if not impossible, to use effectively.

### BRIEF DESCRIPTION OF THE DRAWINGS

FIG. 1 is a diagram of a user interface displayed on a display screen of a mobile device, the user interface showing an option to create a new mobile website.

FIG. 2 is a diagram of the user interface of FIG. 1 showing a template to be selected.

FIG. 3 is a diagram of the user interface of FIG. 1 showing customization options for content shared across all web pages of the mobile website.

FIG. 4 is a diagram of the user interface of FIG. 1 showing customization options for content on an “About” page of the mobile website.

FIG. 5 is a diagram of the user interface of FIG. 1 showing customization options for content on an “About me” page of the mobile website.

FIG. 6 is a diagram of the user interface of FIG. 1 showing customization options for content on a “Gallery” page of the mobile website.

FIG. 7 is a diagram of the user interface of FIG. 1 showing customization options for content on a “Blog” page of the mobile website.

FIG. 8 is a diagram of the user interface of FIG. 1 showing options for creating a new page of the mobile website.

FIG. 9 is a diagram of the user interface of FIG. 1 showing an image source menu.

FIG. 10 is a diagram of the user interface of FIG. 1 showing a list of website on which a data acquisition method may be performed.

FIG. 11 is a flow diagram showing a data acquisition method.

FIG. 12 is a diagram of the user interface of FIG. 1 showing an arrangement of images scraped and filtered from an existing website.

FIG. 13 is a diagram of the user interface of FIG. 1 showing a main graphic being sized in a sizing interface.

FIG. 14 is a diagram of the user interface of FIG. 1 showing customization options for content describing a business on an “About” page of the mobile website.

FIG. 15 is a diagram of the user interface of FIG. 1 showing an arrangement of text scraped and filtered from an existing website.

FIG. 16 is a diagram of the user interface of FIG. 1 showing customization options for content describing business hours on an “About” page of the mobile website.

FIG. 17 is a diagram of the user interface of FIG. 1 showing customization options for content describing business contact information on an “About” page of the mobile website.

FIG. 18 is a diagram of the user interface of FIG. 1 showing customization options for adding content to a new page of the mobile website.

FIG. 19 is a diagram of the user interface of FIG. 1 showing text editing functions.

FIG. 20 is a diagram of the user interface of FIG. 1 showing a method for rearranging containers on a web page.

FIG. 21 is a diagram of the user interface of FIG. 1 showing rearranged containers according to the method of FIG. 20.

FIG. 22 is a diagram of the user interface of FIG. 1 showing a prepared new page of the mobile website.

FIG. 23 is a diagram of the user interface of FIG. 1 showing a preview function of the new page of FIG. 22.

FIG. 24 is a block diagram illustrating an exemplary environment in which the present system and method may be implemented.

FIG. 25 shows a flowchart for a method for a user to first use a temporary account associated with the present system and then convert the temporary account into a full user account.

### DETAILED DESCRIPTION OF THE PREFERRED EMBODIMENT

The present invention will now be discussed in detail with regard to the attached drawing figures which were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as web pages. Websites comprise a collection of connected, or otherwise related, web pages. The combination of all the websites and their corresponding web pages on the Internet is generally known as the World Wide Web (WWW) or simply the Web.

Websites may be created using HyperText Markup Language (HTML) to generate a standard set of tags that define how the web pages for the website are to be displayed. Users of the Internet may access content providers' websites using software known as an Internet browser, such as MICROSOFT INTERNET EXPLORER or MOZILLA FIREFOX. After the browser has located the desired web page, the browser requests and receives information from the web page, typically in the form of an HTML document, and then displays the web page content for the user. A request is made by visiting the website's address, known as a Uniform Resource Locator (“URL”). The user then may view other web pages at the same website or move to an entirely different website using the browser.

In many cases, users use mobile devices, such as smart phones, to browse web pages. Because the display size for a mobile device is limited, conventional web pages, designed for desktop and laptop computers, often do not display well on the device. Because the web page may be relatively wide (in comparison to the mobile device's display), if the entire width of the web page were to be displayed upon the screen of the mobile device, the web page would need to be displayed with a relatively small font and image size in order to fit all of the web page content on the mobile device's screen. This would make the web page difficult to read or view. If, however, the user were to zoom-in on a particular portion of the web page, in order to make reading of the text in that portion more easily read, the web page would become too large to depict on the display of the mobile device. Consequently, when zoomed-in, the user would need to pan the web page both up and down and side-to-side in order to view all of the content of the web page. To remedy this problem, website designers sometimes prepare a second version of the web page that is more suited for display on a mobile device.

Generally, the construction of a web page for display on a mobile device involves constructing a web page having an appropriate geometry and content for display on a mobile device. This may involve resizing and/or rearranging textual and graphic elements of the web page so that the width of the web page, once rendered, does not exceed that of the mobile device's display. Additionally, based upon the technological capabilities of the mobile device, different types of content may be included on the mobile web page. Finally, user interface elements, such as buttons, links, and other controls, may also be arranged so as to be more easily used in conjunction with a touch screen interface. This may involve, for example, making the buttons larger and positioning them further away from one another.

Website designers generally use desktop or laptop-based software applications to construct websites, both mobile and regular. These website-builder applications include a number of graphical user interface elements that enable a user to aggregate and arrange website content. The tools often provide a what-you-see-is-what-you-get (WYSIWYG) interface that allows the user to upload and arrange content, such as text, images, video, and the like, as it will ultimately be displayed on a web page. Because these software applications are constructed in the presumption that the application will be accessed using a conventional desktop computer or laptop, the employed user interfaces are not appropriate for the small touch screen interface associated with most mobile devices.

The present disclosure, therefore, provides an improved system and method for a user to upload and arrange content using a mobile device, such as a smart phone having a touch screen interface. Using the present system, a user can select content from a number of available sources, and then add that content to a particular web page. The user can then designate a particular order in which that content should be displayed. The uploaded content, in the order designated by the user, can then be incorporated into a web page template to create a finished web page and made available over the Web by an appropriate web server. In one implementation, the template is configured for display on a mobile device, though other forms of templates may be utilized. For example, the templates may also be configured to generate web pages suitable for display on a conventional computing device, such as a desktop computer or a laptop.

Alternatively, the content provided by a user using the present system may be utilized in other manners in addition to incorporation into websites. For example, the user may upload content using the present system that is later incorporated into a template suitable for printing as a poster or business card. The uploaded content may also be incorporated into third-party services. For example, a user may use the present system to upload data describing a company. That information may then be automatically incorporated in the company's FACEBOOK or TWITTER profile, for example.

In the present exemplary disclosure, the present system is described as a software application that may be executed on a mobile device. The software application includes a number of user interface screens (see FIGS. 1-23) presented via a touch screen interface, as described below. It will be understood, therefore, that performing actions on the displayed data, such as “selecting” or “clicking” a button or “highlighting” text, as well as performing general actions such as “tapping,” “dragging, and “swiping,” may be commonly understood actions performed by touching the touch screen to generate a control input that the touch screen interface processes to carry out the intended action on the displayed data, though other techniques for providing a user interface may be used in conjunction with the present disclosure.

In one implementation, the present invention is a system comprising a mobile device having a touch screen interface. The mobile device is configured to display an arrangement of display elements, and receive a first control input causing one of the display elements to be selected. The selected one of the display elements has a first position in the arrangement of display elements. The mobile device is configured to receive a second control input indicating that the selected display element is to be repositioned to a second position within the arrangement of display elements, and reposition the selected display element to the second position within the arrangement of display elements.

In another implementation, the present invention is a system comprising a mobile device having a touch screen interface. The mobile device is configured to display an arrangement of display elements, receive a control input causing a new display element to be entered into a first position in the arrangement of display elements, and prompt a user to provide a Uniform Resource Locator referring to a web page. The mobile device is configured to retrieve a plurality of includable elements from the web page, display the plurality of includable elements from the web page for selection by the user, and, upon receiving a selection of one of the plurality of includable elements by the user, insert the selected one of the includable elements into the new display element in the first position in the arrangement of display elements.

In another implementation, the present invention is a method comprising displaying an arrangement of display elements, and receiving a first control input causing one of the display elements to be selected. The selected one of the display elements has a first position in the arrangement of display elements. The method includes receiving a second control input indicating that the selected display element is to be repositioned to a second position within the arrangement of display elements, and repositioning the selected display element to the second position within the arrangement of display elements.

In another implementation, the present invention is a method comprising displaying an arrangement of display elements, receiving a control input causing a new display element to be entered into a first position in the arrangement of display elements, and prompting a user to provide a Uniform Resource Locator referring to a web page. The method includes retrieving a plurality of includable elements from the web page, displaying the plurality of includable elements from the web page for selection by the user, and, upon receiving a selection of one of the plurality of includable elements by the user, inserting the selected one of the includable elements into the new display element in the first position in the arrangement of display elements.

In another implementation, the present invention is a non-transitory computer-readable storage media storing instructions that, when executed by at least one computing device, cause the at least one computing device to display an arrangement of display elements, and receive a first control input causing one of the display elements to be selected. The selected one of the display elements has a first position in the arrangement of display elements. The instructions cause the at least one computing device to receive a second control input indicating that the selected display element is to be repositioned to a second position within the arrangement of display elements, and reposition the selected display element to the second position within the arrangement of display elements.

In another implementation, the present invention is a method comprising identifying a Uniform Resource Locator referring to a web page, retrieving a plurality of includable elements from the web page, and providing the plurality of includable elements from the web page for selection by a user using a user interface.

In another implementation, the present invention is a system comprising a computing device configured to identify a Uniform Resource Locator referring to a web page, retrieve a plurality of includable elements from the web page, and provide the plurality of includable elements from the web page for selection by a user using a user interface.

FIG. 24 is a block diagram illustrating an exemplary environment in which the present system and method may be implemented. Mobile device 10, such as a smartphone, is configured to execute software, such as software providing the user interface screens depicted in FIGS. 1-23. Mobile device 10 includes a display 16 configured to display the output screens, and a touch screen interface configured to receive user input, as described below.

Using mobile device 10, the present system enables a user to aggregate content from a number of sources. That content can then be arranged and incorporated into a template and published as a website. The content may include text, images, videos, or other content that may be incorporated into a web page and delivered over the Internet to a requesting device.

Mobile device 10 is configured to communicate data to data server 14, where the data may include content, such as text, multimedia, and other data, as well as a description of the ordering of that information. In order to associate the data received from mobile device 10 with the correct user (or temporary account), data server 14 stores account information in an account information repository 20. In the case of a temporary account, the account information includes a unique identifier associated with a particular mobile device 10, or installed software package on mobile device 10. In the case of a full account, the account information includes a user's name, email address, password, and other commonly stored account information.

Data server 14 includes a multimedia repository 22 and website content repository 24 to store data received from mobile device 10. The website content repository 24, in addition to storing portions of the content that may be incorporated into a web page, stores data describing the order in which that content will appear on a particular web page.

Data server 14 also stores a number of templates 26 into which the data provided by mobile device 10 may be incorporated in order to construct finished web pages suitable for distribution via the Internet. In one implementation, after the data has been incorporated into a particular template, the finished web page is made publicly available using web server 12. Web server 12, therefore, hosts the web page and may comprise a separate server from data server 14, or may be implemented by the same server as data server 14.

Finally, as described below, mobile device 10 may be in communication with a content website 28. Content website 28 represents a separate website from which content may be scraped. That scraped content, including text, images, and/or video, as described below, may then be incorporated in to the user's web page.

The environment depicted in FIG. 24 is only exemplary. In various implementations the functionality provided by mobile device 10 and data server 14 may be solely provided by either mobile device 10 or data server 14, or certain functionality may be distributed across both devices. For example, rather than store the web page content solely on data server 14, that content could instead by stored on mobile device 10, or mirrored on mobile device 10 (for example, in a cached copy of the web page content). When the web page content is stored on mobile device 10, mobile device 10 rather than data server 14 could incorporate the content into a template, which, using web server 12, could be published on the Internet.

Referring to FIG. 1, the system outputs a user interface using the mobile device to display a selectable option 101 to create a new mobile website. In one embodiment, the option 101 to create a new mobile website may be presented once the user logs into an account. In one implementation, however, the option 101 to create a new mobile website may be presented to the user upon initiating the application, allowing the user to begin creating a new website without having to create or log into a permanent account. This advantageously allows the user to begin using the application immediately, while also improving user retention for the application provider because users are more likely to use the application if they are not required to enter personal information and create an account to do so.

To proceed without creating a permanent account, the system may create a temporary project space (on either the mobile device 10 or the data server 14, for example), in which to store the user's new website project. The temporary space may have an identifier, which at least allows the project space to be located. The identifier may further associate the mobile device with the project space and may be stored in account information repository 20 on data server 114 (see FIG. 1). In some embodiments, the identifier may be created using a device identifier for the user's mobile device, such as a media access control (“MAC”) address, phone number, or cell network identifier. In a particular example where the application is an APPLE APPSTORE application, the system creates a string comprising the MAC address of the device concatenated with the bundle identifier assigned to the application by the AppStore. That string can then be encrypted using MD5 hashing or another encryption algorithm. The resulting hash value is used as the identifier for the project spade. Using only that string, it is therefore possible to unique identify the application running on a particular mobile device, and, thereby, the data that has been provided by that mobile device for incorporation into a web site.

If the user has, or later decides to create, a permanent account, such as during the publication function described below, the server may associate the project space with the user's permanent account. To create the permanent account, the information describing the temporary user account is updated with the user's actual information, including name, e-mail address, password, and the like.

For example, FIG. 25 shows a flowchart for a method for a user to first use a temporary account associated with the present system and then convert the temporary account into a full user account. In step 50 the user begins using the software application. This may involve the user first downloading and installing the software. Once appropriately installed, the user activates the software, for example, by tapping on an icon associated with the software in a listing of available software. After initiating the software, in step 52 a temporary account is created. The temporary account does not include the user's personal information. Instead, the temporary account is associated with the user's mobile device (or the software application running on the user's mobile device). This enables the user to utilize the software, and save and manipulate content, but the user is not required to create a formal account before using the software. Accordingly, while the user uses the software, in step 54 any data created by the user is stored in association with the temporary user account. Eventually, in step 56, the user initiates creation of a formal user account. This may occur, for example, by the user explicitly requesting to create a user account (for example, by clicking on a ‘create user account’ link or button). Alternatively, the user may take some action that triggers the creation of a formal user account (if the user is currently using a temporary account). In the present system, for example, once the user attempts to publish a created web page, where the user (and, thereby, the published web page) are associated with a temporary user account, the user may be prompted to create a formal user account (if the user is not already using such an account). In order to create the formal user account, in step 58 necessary user information is collected via an appropriate form interface. The user information may include an email address, name, password, and the like. Once the user information is collected, in step 60 the temporary user account is updated to include the user's information.

Referring to FIG. 2, at the start of a new project, the user may be prompted to select a template 200 from a template set. The template 200 may contain a default layout for the mobile website. The layout may include web elements that are common to mobile websites, including without limitation: a navigation interface 205 featuring commonly used navigation elements; a main graphic 210 such as a business logo or profile photo; a page title 215; one or more headlines 220 to draw a visitor's attention; and content 225, which may include text, graphics, videos, and other types of web elements. The application may provide a wide variety of templates 200 designed to appeal to differing businesses and individuals. For example, a freelance photographer's default layout may be graphically intensive and emphasize images, while a small restaurant's default layout may emphasize the restaurant's logo, contact information, and a link to its menu. Some or all elements of the default layout may be rearranged as desired by the user, or some or all of the elements may be static.

FIGS. 3-8 illustrate a portion of a user interface that allows the user to customize the selected template 200 with his personal or business information and unique content. The user may select the web pages to be included in the website and the content to be displayed on each web page. The screen may be divided vertically or horizontally into two sections. A first section 300 may display page titles 310 for web pages that have default layouts according to the selected template 200. Suitable web pages with a default layout may include an “About” or “About Me” page for conveying biographical or business history information, a “Contact” page for conveying address, phone, social media profiles, and other contact information, and personal content pages such as a “Gallery” or a “Blog.” The first section 300 may further display an option 315 to create a new web page that may appear in the list of page titles 310. The new web page may have a default layout, or the user may select a default layout typically applied to another web page, or the new web page may be blank. In some embodiments, the page titles 310 may be used to create the navigation elements in the navigation interface 205. That is, the page titles 310 may be displayed on the button hyperlinks to each web page. The user may change the appearance of the button hyperlinks, and rename the web page, by changing the page title 310 in the first section 300. The first section 300 may further include a flag 320 indicating whether the web page is “on” or “off” in the website display.

A second section 325 may display settings buttons 330 that may be selected to access and customize the content of the corresponding web page. The second section 325 may include a toggle 335 for the discrete types of content accessible through the settings buttons 330. The user may turn each toggle 335 on or off to include or exclude the corresponding content for the selected web page. Referring to FIG. 3, some elements may be shared across all pages in the website. These elements may depend on the template 200 selected and may include, without limitation: the main graphic 210, a splash image that may appear behind the main graphic 210, and one or more social media connectors, such as links to the user's FACEBOOK profile or TWITTER account. Referring to FIGS. 4-7, examples of content that may be inserted into corresponding web pages using a default layout include, without limitation: on an “About” page for a business, content describing the business history, business hours, and contact information for the business; on an “About Me” page for an individual, biographical content and one or more photos; on a “Gallery” page, photos and other images to present in a gallery; on a “Blog” page, blog entries and their associated elements, such as posting time and location, trackback entries, and comments. Referring to FIG. 8, the user may choose to edit a new page, allowing the user to add customized content as described below with reference to FIGS. 18-22.

Referring to FIG. 9, when the user selects to add a main graphic 210, the user may be presented with an image source menu 400 prompting the user to select a source location that may include a large number of images, from which the user can select the desired image file. The user may, for example and without limitation, choose to retrieve the image file from an existing website, search for the image file on one or more photo hosting services such as FLICKR and INSTAGRAM, select the image file from a storage location on the user's device, or create a new image file by taking a photo with the device. Referring to FIG. 10, if the user chooses to retrieve the image file from an existing website, the user may be prompted to enter the existing website's address in an address field 405, search for the existing website in a search field 410, or select the existing website from a list 415 of previously visited websites.

Referring to FIG. 11, when the user selects the desired existing website, the server (or, in some cases, the mobile device) may perform one or more data acquisition methods in which the source code of the existing website may be analyzed to identify elements of the existing website that the user may wish to incorporate into the mobile website, the elements referred to herein as “includable elements.” The data acquisition methods may include crawling 505 the existing website to visit all or a subset of the web pages comprising the existing website or being related to the existing website, scraping 510 data from the source code of each of the visited web pages, and filtering 515 the scraped data to obtain a data set containing includable elements. In one implementation, the web pages to visit are identified by following links present on the website identified by the user, where the links point to the domain at which the website is located (links pointing to other domains may not be followed). In some implementations, redirections and frames that may lead to relevant content (even located on other domains) may also be followed to identify candidate web pages from which content may be scraped. For example, although a link may point to another domain (and otherwise may not be followed), certain domains may be defined for which relevant content will likely be found. Links pointing to those domains will then be followed to identify web pages that may be scraped, even if they point to domains that are different from the domain of the original website being scraped. For example, when scraping a web page for images, the web page may link to an image repository located at another domain, where that domain is well known for hosting images (e.g., tumblr.com, flickr.com, and the like). In that case, the link, even though pointing to a different domain, is likely to point to a web page that contains relevant content, namely images. Similarly, links that points to content delivery networks (CDNs) are also likely to contain relevant content and may be followed when scraping a particular website for content.

Once all desired web pages are scraped (or, in some cases, while the web pages are being scraped), the includable elements may be presented 520 to the user for selection. In implementations where the scraping is performed by a server, the retrieved includable elements can be transmitted by the server to the mobile device, where the includable elements can be displayed for selection by the user. Alternatively, when the scraping is performed by a mobile device, the retrieved includable elements can be directly displayed for selection by the user. The data acquisition methods may be adapted for use in identification of particular types of includable elements, including without limitation: images from the website or a subset thereof, such as image suitable for use as the main graphic 210; videos embedded in or downloadable from the website; and text elements, including text elements that may be grouped together, such as a headline, byline, and content together comprising a news article. Performing the data acquisition methods may therefore include providing the desired element type to collect and additional parameters for determining the includable elements. The element type and parameters may be entered by the user, or may be default arrangements of elements types and parameters that are provided for the methods upon selection by the user of a customized element to add.

For example, when the user wishes to add the main graphic 210 by retrieving it from an existing website, the server may crawl 505 several of the web pages of the website, scraping 510 all images from the web pages. The images may be identified by HTML tags, such as the <img> tag, or by filenames ending in a recognizable file image file extension such as .jpg or .gif, or by inclusion in a cascading style sheet (“CSS”) file that is included on or linked to from the web page. The server may filter 515 the resulting collection of images according to one or more parameters or criteria that help identify graphics used as a logo on the existing website. These parameters may include frequency of use across web pages, location of the graphic, file name indicators such as “logo,” “masthead,” or the business' name in the file name, and size of the image. Images that satisfy the parameters are added to the set of includable elements, which is presented 520 to the user, preferably graphically as illustrated in FIG. 12. Depending upon the system implementation, the mobile device may directly access and retrieve the images that are presented to the user for selection. When a particular image has been selected, that image may be stored on the mobile device. The image can then be uploaded to a repository on data server 14 (see FIG. 2). Alternatively, the images may be scraped by a separate computer, such as data server 14 (see FIG. 24), and then, once retrieved, the images may be transmitted to the mobile device for display to a user.

In another example, where the user is adding images to the mobile website other than the main graphic 210, the server may crawl 505, scrape 510, and filter 515 as described above for the main graphic 210, except that the filtering 515 parameters may be less restrictive. In particular, images identified as includable elements are any images at least 65 pixels wide and at least 29 pixels tall. Images that do not meet these dimensions are considered unlikely to be wanted for inclusion in the mobile website.

Referring again to FIG. 9, if the user chooses an option, such as selecting the image file from a storage location on the user's device or taking a new photo, that requires an upload of the image file or other data to the project space, selecting the data may initiate the upload process. In some embodiments, the uploading may begin immediately upon selection of any data, and may be performed in the background as the user continues using the user interface in the foreground. In this manner, the data may be uploaded without manual confirmation from the user, so that it will be available more quickly should the user wish to preview the website, as described below, or otherwise manipulate the uploaded data.

For example, when revising content that may be used in a particular web page, a user may wish to insert an image into the web page. In order to add the image, the user will first navigate to the desired image on an appropriate repository (such as one of the repositories listed in image source menu 400 in FIG. 9). After locating the image that the user wishes to insert into the web page, the user will select that image. The image will then be incorporated into the display of the web page that the user is currently editing. At this point, though, the web page being edited has not yet been saved. In order to save the page, the user must first indicate that the user is done editing the page and save the web page (for example, by clicking a save button). However, in the present implementation, upon selecting the image (and before the edited web page itself is saved), the image will begin uploading in the background (for example, to multimedia repository 22 of data server 14 in FIG. 24). As such, later, when the user saves the web page, the image (or at least a portion thereof) will have already been uploaded to data server 14, reducing the amount of time required to save the web page content to data server 14. If, however, the user should elect to delete the selected image before saving the revised content, the portion of the image that was uploaded by this background-uploading procedure may simply be deleted from data server 14.

Referring to FIG. 13, when the user has selected a main graphic 210 to display, a sizing interface 600 may be presented. The sizing interface 600 may aid the user in resizing and positioning the main graphic 210 so that it is properly displayed on the mobile website within the selected template. A sizing box 605 may set a maximum width of the main graphic 210 to be equal to the width of the display screen. The sizing box 605 may further set a maximum height, which may be adjustable by the user or set at a typical useful height, such as ⅓ of the screen height. The sizing interface 600 may further include a background selector 610 comprising one or more options 615, 620, 625 for the background color to be displayed in any part of the sizing box 605 that is not filled by the main graphic 210. The available background colors may be any color; however, the most frequently selected background colors are reflected in a first option 615 of white, a second option 620 of black, and a third option 625 that is the color of the bottom right pixel of the main graphic 210.

Referring to FIG. 14, when the user selects to add personal or business information, such as to the “About” page, one or more text fields may be presented to collect the information. The text fields may include, without limitation: a company name field 700; a tagline field 705 to contain the business's slogan, mission statement, tagline, or other focus statement; and an extended information field 710 to contain biographical or historical information or other personal or business information that the user wishes to include on the website.

Due to the small, touch-sensitive nature of mobile device keypad interfaces, it may be advantageous to insert into the text fields text that has already been drafted. The user may therefore be presented with the option of retrieving the drafted text from an existing website. When the user selects the desired existing website, the server may perform a data acquisition method according to FIG. 11 to retrieve text therefrom. The server may retrieve textual statements, which may be phrases, complete sentences, paragraphs, headlines, headings, subheadings, and the like, or combinations thereof, by scraping 510 the web pages of the existing website. The filtering 515 parameters for text may include HTML tag-based inclusion or exclusion rules including, without limitation: recursively check that the text is positioned inside particular tags, such as <div>, <section>, or <article>, unless that text is over a certain word count threshold; ignore text inside particular tags, such as <form> tags; and ignore text inside tags that have certain attributes or strings indicating the text is irrelevant, including such attributes as “id,” “class,” and “rel,” and strings such as “nav,” “head,” “foot,” “sidebar,” “menu,” “widget,” “banner,” “fb,” “captcha,” “action,” “nofollow,” “post-notes,” “paging,” “infobar,” and the like. The text elements that pass through the filtering 515 may be grouped according to their parent tags, if any, and added to the set of includable elements, which is presented 520 to the user, preferably graphically as illustrated in FIG. 15.

In one implementation, once retrieved, the text scraped from the target website is normalized. Normalization may involve identifying and removing duplicative text, removing characters such as tabs, new lines, and the like, removing large white spaces, merging multiple paragraphs into a single paragraph (for example, if the multiple paragraphs are enclosed within a single <div> tag they be merged into a single paragraph), and other clean-up of the retrieved text.

When a user uses the method depicted in FIG. 11 to add content to a web page (such as text or an image), the present system may be configured to maintain a record of the location from which the scraped content was retrieved. For images, this may involve storing the URL of the image. By storing a record identifying the location of the scraped content, the scraped web page may be monitored and, if the scraped content is updated or otherwise modified on the scraped web page, the modified content can be similarly updated on the user's web page. FIGS. 16 and 17 illustrate additional text fields and options related to entering business information. Referring to FIG. 16, business hours may be entered for display on the website by direct textual entry of the hours, or by using a drop down menu or swipe menu 800. Referring to FIG. 17, the business contact information may be entered by direct textual entry into text fields 810. The user may be presented with the option 815 of selecting a GPS localization centered on the user's device, if the user is present at the business location when creating the mobile website. The user may confirm the GPS's display of the correct address, which may populate the text fields 810 with the appropriate data.

Referring to FIG. 18, the user may add custom content to one or more of the web pages, including by modifying the default layout of corresponding web pages or by creating a new web page as described with reference to FIG. 8. Custom content may be added by adding new containers for the content to the web page. A container is an invisible design element that holds some content that can be incorporated into a template for display on a web page. In the illustrated example of FIG. 18, three containers 900, 905, 910 for text content are displayed, and a new container is added by selecting the type of content for the container, the selecting performed by pressing the text button 920 for any type of text entry, the image button 925 for adding any type of image, or the video button 930 for adding a stored or streamed video. A new container may be appended to the bottom of the arrangement of existing containers, or the new container may be interposed between two existing containers by selecting the insert button 935 at the desired insertion location. Two adjacent containers, which may have the same type or different types of content, may be merged into a single container by selecting the merge button 940 between the target containers to be merged.

Referring to FIG. 19, text content in a text container may be added, deleted, and modified using a keypad interface 950 provided by the user's device or otherwise supplied to the application. A web button 945 may be provided for the user to select if the user wishes to add text content to the text container from an existing website. Text may be highlighted for editing, which may present a popup editing menu 955. The editing menu 955 may include one or more text formatting options, such as rich text additions including bold, italic, underline, resized, indented, or hyperlinked text. Selecting an option from the editing menu 955 applies the selected formatting or action to the highlighted text.

Referring to FIGS. 20-21, the order of the containers on the web page may be rearranged. The user interface may apply the click-and-drag method known in the art for moving elements on a touch screen. However, this method is prone to errors in placement, particularly if the desired new location for a container being moved is off-screen. Accordingly, the user interface may instead use another repositioning method wherein the user first selects the container to be moved by tapping and holding upon the container. The user interface displays one or more indicators showing the positions to which the selected container may be moved, and the user taps the desired position. This allows the user to scroll down the vertical arrangement of containers to see indicators off-screen without having to hold down his gesture on the touch screen. Upon the user's tapping of the desired position, the containers are rearranged. FIG. 20 shows the second container 905 selected for movement, and an indicator 960 is displayed between the third container 910 and a fourth container 915. If the user chooses to place the second container 905 at the position of the indicator 960, the containers 900, 905, 910, 915 are rearranged as shown in FIG. 21.

When the containers are arranged in their desired vertical order and the desired content is entered into the containers, as shown partially in FIG. 22, the user may save and preview the website to determine if the layout of each web page is properly displayed. As shown in FIG. 23, the preview may display the arrangement of elements and containers according to the default and customized layouts of each web page created or modified by the user. If the preview shows that the website is ready for publication, the user may choose to publish the website. At this point, the user may create or log into his permanent account and obtain a URL for the mobile website, after which the mobile website will be viewable by visitors to the URL. Note that if the user has been utilizing a temporary user account while constructing the website, upon requesting that the website by published and made publicly available, the user may be prompted to provide login information that can be used to create a permanent account for the user.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As a non-limiting example, the steps described above (and all methods described herein) may be performed by any central processing unit (CPU) or processor in a computer or computing system, such as a microprocessor running on a server computer, and executing instructions stored (perhaps as applications, scripts, apps, and/or other software) in computer-readable media accessible to the CPU or processor, such as a hard disk drive on a server computer, which may be communicatively coupled to a network (including the Internet). Such software may include server-side software, client-side software, browser-implemented software (e.g., a browser plugin), and other software configurations.

The present invention has been described in terms of one or more preferred embodiments, and it should be appreciated that many equivalents, alternatives, variations, and modifications, aside from those expressly stated, are possible and within the scope of the invention.

We claim:

1. A method, comprising:
displaying an arrangement of display elements;
receiving a first control input causing one of the display elements to be selected, the selected one of the display elements having a first position in the arrangement of display elements;
receiving a second control input indicating that the selected one of the display elements is to be repositioned to a second position within the arrangement of display elements; and
repositioning the selected one of the display elements to the second position within the arrangement of display elements.

2. The method of claim 1, wherein the arrangement of display elements is a vertical arrangement of display elements that is longer than a touch screen interface displaying the arrangement of display elements.

3. The method of claim 1, wherein the selected one of the display elements includes text, and when a portion of the text is selected, including displaying a number of rich text options that may be applied to the selected portion of the text.

4. The method of claim 1, including receiving an input to publish the arrangement of display elements as a web page.

5. The method of claim 4, including, when the web page is associated with a temporary user account:
prompt a user to provide account information including at least one or a name and an email address; and
cause the account information to be associated with the temporary user account.

6. The method of claim 1, wherein the first control input includes a push and hold action performed by a user on a touch screen interface.

7. The method of claim 6, wherein the second control input includes a tap action performed by the user on the touch screen interface.

8. The method of claim 1, wherein, after the one of the display elements is selected, displaying a number of candidate reposition locations for the selected one of the display elements in the arrangement of display elements.

9. A method, comprising:
displaying an arrangement of display elements;
receiving a control input causing a new display element to be entered into a first position in the arrangement of display elements;
prompting a user to provide a Uniform Resource Locator referring to a web page;
retrieving a plurality of includable elements from the web page;
displaying the plurality of includable elements from the web page for selection by the user; and
upon receiving a selection of one of the plurality of includable elements by the user, inserting the selected one of the includable elements into the new display element in the first position in the arrangement of display elements.

10. The method of claim 9, wherein the plurality of includable elements include images.

11. The method of claim 10, including filtering the plurality of includable elements to identify a subset of the plurality of includable elements meeting criteria.

12. The method of claim 11, wherein the criteria specify a particular filetype.

13. The method of claim 11, wherein the criteria specify minimum image dimensions.

14. The method of claim 10, wherein, upon receiving a selection of one of the plurality of includable elements, uploading the selected one of the plurality of includable elements to a server.

15. The method of claim 10, wherein, upon receiving a selection of one of the plurality of includable elements, prompting the user to select a background color for the selected one of the plurality of includable elements.

16. The method of claim 9, wherein the plurality of includable elements include text.

17. A non-transitory computer-readable storage media storing instructions that, when executed by at least one computing device, cause the at least one computing device to:
display an arrangement of display elements using a touch screen interface;
receive a first control input causing one of the display elements to be selected, the selected one of the display elements having a first position in the arrangement of display elements;
receive a second control input indicating that the selected display element is to be repositioned to a second position within the arrangement of display elements; and
reposition the selected display element to the second position within the arrangement of display elements.

18. The non-transitory computer-readable storage media of claim 17, wherein the arrangement of display elements is a vertical arrangement of display elements that is longer than the touch screen interface.

19. The non-transitory computer-readable storage media of claim 17, wherein the selected one of the display elements includes text, and when a portion of the text is selected, including displaying a number of rich text options that may be applied to the selected portion of the text.

20. The non-transitory computer-readable storage media of claim 17, wherein the instructions cause the at least one computing device to receive an input to publish the arrangement of display elements as a web page.
